(19) United States
(12) Patent Application Publication
(10) Pub. No.: US 2026/0042372 A1
(43) Pub. Date: Feb. 12, 2026

(54) CHARGING PROCESS, CHARGING STATION, CHARGER AND ELECTRIC VEHICLE FOR A SIMPLE AND OPTIMAL USE OF REGENERATIVELY GENERATED ELECTRICAL ENERGY

(71) Applicant: AUDI AG, Ingolstadt (DE)

(72) Inventors: Alexander KUPFER, Mannheim (DE); Philipp RENNER, München (DE); Daniel STEMMER, Marzling (DE)

(21) Appl. No.: 19/292,686

(22) Filed: Aug. 6, 2025

(30) Foreign Application Priority Data
Aug. 7, 2024 (DE) 102024122471.1

(51) Int. Cl. B60L 53/63

(52) U.S. Cl. CPC B60L 53/63

(57) ABSTRACT

A process for charging an electric vehicle, in which an electric vehicle connected to a charging station is charged with electrical energy provided by the charging station, and the electric vehicle and the charging station cooperate during charging, and a charging station for an electric vehicle, a charger for an electric vehicle, and an electric vehicle.

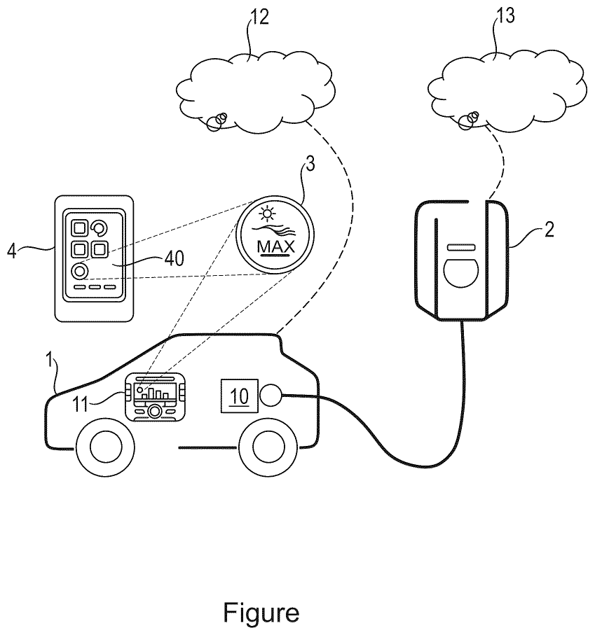

### BACKGROUND

### Technical Field

The present disclosure relates to a process for charging an electric vehicle, in which an electric vehicle connected to a charging station is charged with electrical energy provided by the charging station, and a charger of the electric vehicle and the charging station cooperate during charging. Furthermore, the present disclosure relates to a charger for an electric vehicle, an electric vehicle, and a charging station for an electric vehicle.

### Description of the Related Art

Processes of the type mentioned above, in various configurations, are part of the prior art and are used to charge a traction battery of an electric vehicle with electrical energy. For charging, the electric vehicle is connected to the charging station. The electric vehicle charger and the charging station cooperate to control charging the electric vehicle, i.e., to initiate, modify while charging, and/or stop.

The electrical energy provided by the charging station generally comprises a regenerative portion, i.e., regeneratively generated electrical energy, and a fossil portion, i.e., electrical energy generated using fossil energy sources. Regeneratively generated electrical energy is inevitably subject to weather-related and diurnal fluctuations. As a result, the regenerative portion of the electrical energy provided by the charging station fluctuates depending on the weather and the time of day.

Nevertheless, for ecological reasons, it is desirable to use as high a portion as possible of regeneratively generated electrical energy or as low a portion as possible of fossil-generated electrical energy to charge the electric vehicle.

For example, DE 10 2023 117 767 A1 discloses a process for charging an electric vehicle, in which a difference between the electrical energy required for charging and the regeneratively generated electrical energy provided by a charging station is balanced. A user can configure an action for balancing using a graphical user interface.

CN 108327569 A discloses a further process for charging an electric vehicle, in which an electric vehicle is charged with regeneratively generated electrical energy provided by a local wind turbine and/or electrical energy provided by a power grid during travel on a charging lane of a roadway provided with charging elements, in accordance with a weather-dependent supply and a traffic-dependent demand.

CN 109986987 A discloses a process for charging an electric vehicle, in which a charging point connected to a power grid and comprising a solar module charges an electric vehicle connected to the charging station preferably with electrical energy provided by the solar module and additionally with electrical energy provided by the power grid.

Although known charging processes allow the preferential use of regeneratively generated electrical energy, they require a complex configuration and/or do not achieve an optimal regenerative portion of the charged electrical energy due to insufficient flexibility.

### BRIEF SUMMARY

According to the present disclosure a process for charging an electric vehicle optimizes a regenerative portion of a charged electrical energy and is easy to initiate. Further, the present disclosure provides a charger for an electric vehicle, an electric vehicle, and a charging station for an electric vehicle.

An embodiment of the present disclosure is a process for charging an electric vehicle, in which an electric vehicle connected to a charging station is charged with electrical energy provided by the charging station, and a charger of the electric vehicle and the charging station cooperate during charging. The charging station can be designed as a so-called wall box. The electrical energy provided by the charging station can comprise a fossil portion and a regenerative portion. Cooperating includes mutual signaling respective operating states and actions.

According to the present disclosure, the electric vehicle and the charging station cooperate during charging to optimize a regenerative portion of the charged electrical energy in a specific charging mode, and said specific charging mode is activated by simply pressing a dedicated charging button. The dedicated charging button enables easy initiation of the charging process. The specific charging mode can be activated by way of the dedicated charging button from the beginning or at any time during charging without any configuration.

In particular, the regenerative portion is optimized in isolation, i.e., not exclusively relative to the fossil portion. In other words, optimizing is not limited to maximizing the portion of regenerative energy relative to the portion of fossil energy.

The electric vehicle and the charging station can cooperate by way of a direct communication link between the electric vehicle and the charging station. Alternatively, the electric vehicle and the charging station can cooperate by way of a cloud connection of the electric vehicle and/or a cloud connection of the charging station. In particular, the electric vehicle can be connected to a vehicle cloud, and the charging station can be connected to a charging station cloud different from the vehicle cloud.

In one embodiment, an infotainment system of the electric vehicle or a mobile terminal application provides the dedicated charging button. The infotainment system can be used by an occupant of the electric vehicle, i.e., a user located inside the electric vehicle, to activate the specific charging mode. The mobile terminal can be used by a user located outside the electric vehicle like a remote control, i.e., remotely, to activate the specific charging mode. The application can be proprietary software provided by a manufacturer of the vehicle and associated with the electric vehicle for controlling functions of the electric vehicle.

Preferably, a user interface of the infotainment system or application provides the dedicated charging button at a top level of the user interface. This allows for particularly quick access to the dedicated charging button. The charging button can be arranged on a start page of the user interface.

Ideally, an excess portion of the regenerative portion is maximized. This excess portion consists of regeneratively generated electrical energy that cannot easily be fed into the power grid and therefore remains unused. However, the specific charging mode allows feeding and use of excess regeneratively generated electrical energy, thereby conserving other electrical energy portions more effectively by charging. The excess regeneratively generated electrical energy is preferably provided by regenerative energy converters, such as, for example, solar panels or wind turbines, which are ideally located near the charging station.

Optimizing may include temporarily interrupting charging if the charging station does not provide an excess portion. Time intervals are specifically used to charge the electric vehicle when an excess portion of regeneratively generated electrical energy is available, while complementary time intervals are avoided.

After charging, the electric vehicle or the charging station generates a report relating to the charging and provides the generated report. The report indicates an efficiency of the charging process, i.e., the degree of utilization of excess regeneratively generated electrical energy.

When activating the specific charging mode, the charger advantageously signals to the charging station a maximum duration of charging and/or a flexible charging schedule. The maximum duration defines a time interval in which a predetermined charging target, such as, for example, a state of charge (SoC) of 80%, is to be achieved. Within the defined time interval, as much excess regeneratively generated electrical energy as possible is used to charge the electric vehicle. This variant is suitable if the electric vehicle is parked for a few hours, for example, overnight.

The signaled temporal flexibility gives higher priority to the use of excess regeneratively generated energy than adhering to a maximum charging duration. This variant is suitable if the electric vehicle will not be used for an extended period of time.

Another embodiment of the present disclosure is a charging station for an electric vehicle. The charging station can be designed as a wall box and is used to charge the electric vehicle, more specifically a traction battery or high-voltage (HV) battery of the electric vehicle. The charging station comprises a control unit configured to cooperate with a charger of the electric vehicle during charging the electric vehicle connected to the charging station.

According to the present disclosure, the charging station is configured to participate in a process according to an embodiment of the present disclosure. In other words, the charging station can execute the process together with a correspondingly configured electric vehicle. The process enables the charging station to use a highest possible portion of excess regeneratively generated electrical energy to charge the correspondingly configured electric vehicle.

Another embodiment of the present disclosure is a charger for an electric vehicle. The charger is used to control charging a traction battery of the electric vehicle. The charger is configured to cooperate with a charger of a charging station connected to the electric vehicle for charging the electric vehicle.

According to the present disclosure, the charger is configured to participate in a process according to an embodiment of the disclosure. In other words, the charger can execute the process together with a correspondingly configured charging station. The process enables the charger to use a highest possible portion of excess regeneratively generated electrical energy to charge the electric vehicle when the electric vehicle is connected to the correspondingly configured charging station.

Another embodiment of the present disclosure is an electric vehicle. The electric vehicle comprises a traction battery and a charger connected to the traction battery for controlling charging the traction battery.

According to the present disclosure, the electric vehicle comprises a charger according to an embodiment of the disclosure. Thanks to the charger according to the disclosure, the electric vehicle can be charged in a targeted manner with excess regeneratively generated electrical energy, and charging can be initiated easily.

One advantage of the process according to the disclosure is that it optimizes a regenerative portion of the charged electrical energy and is easy to initiate. Targeted charging the electric vehicle with excess regeneratively generated electrical energy utilizes regenerative energy more efficiently, reduces the consumption of other forms of energy, and relieves the load on the power grid to which the charging station is connected.

### BRIEF DESCRIPTION OF THE SEVERAL VIEWS OF THE DRAWING

The present disclosure is schematically illustrated in the drawings using an embodiment and will be further described with reference to the drawings. In the drawings:

The FIGURE shows an electric vehicle according to an embodiment of the disclosure.

### DETAILED DESCRIPTION

The FIGURE shows an electric vehicle 1 according to an embodiment of the present disclosure. Electric vehicle 1 comprises a charger 10 according to an embodiment of the disclosure. Electric vehicle 1 is arranged at a charging station 2, for example a wall box, and connected to charging station 2. Charger 10 and charging station 2 are each configured to participate in a process according to an embodiment of the disclosure for charging electric vehicle 1 as follows and to execute the process according to the disclosure together, i.e., cooperatively.

A specific charging mode is activated by simply pressing a dedicated charging button 3. An infotainment system 11 of electric vehicle 1 can provide dedicated charging button 3. Alternatively, an application 40 of a mobile terminal 4 can provide dedicated charging button 3. Ideally, a user interface of infotainment system 11 or application 40 provides the dedicated charging button 3 at a top level of the user interface.

When activating the specific charging mode, charger 10 of charging station 2 can signal a maximum duration of charging and/or a temporal flexibility of the charging.

Electric vehicle 1 connected to charging station 2 is charged with electrical energy provided by charging station 2. In one or more implementations, the charging station 2 includes at least one processor and at least one memory storing instructions that, when executed by the at least one processor, cause the charging station 2 to perform the acts of the charging station 2 described herein.

During charging, charger 10 of electric vehicle 1 and charging station 2 cooperate to optimize a regenerative portion of the charged electrical energy in the specific charging mode. For example, electric vehicle 10 and charging station 2 cooperate by way of a direct connection between electric vehicle 1 and charging station 2. Alternatively, charger 10 and charging station 2 can cooperate by way of at least one cloud, in particular a vehicle cloud 12 and a charging station cloud 13 different from vehicle cloud 12, to which electric vehicle 1 and charging station 2 are each connected. In one or more implementations, the charger 10 includes at least one processor and at least one memory storing instructions that, when executed by the at least one processor, cause the charger 10 to perform the acts of the charger 10 described herein.

Preferably, an excess portion of the regenerative portion is maximized. To this end, optimizing may include temporarily interrupting charging if charging station 2 does not provide an excess portion.

Electric vehicle 1 can generate and provide a report relating to the charging after charging. Alternatively, charging station 2 can generate and provide a report relating to the charging after charging.

German patent application no. 102024122471.1, filed Aug. 7, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A process for charging an electric vehicle, comprising:
charging, by a charging station, an electric vehicle connected to the charging station with electrical energy provided by the charging station;
optimizing, by a charger of the electric vehicle or the charging station, a regenerative portion of the electrical energy provided by the charging station during the charging in a specific charging mode; and
activating, by the charging station or the charger, the specific charging mode in response to pressing of a dedicated charging button.

2. The process according to claim 1, wherein an infotainment system of the electric vehicle or an application of a mobile terminal provides the dedicated charging button.

3. The process according to claim 2, wherein a user interface of the infotainment system or the application provides the dedicated charging button at a top level of the user interface.

4. The process according to claim 1, wherein the optimizing includes maximizing an excess portion of the regenerative portion of the electrical energy provided by the charging station.

5. The process according to claim 1, wherein the optimizing includes temporarily interrupting the charging if the charging station does not provide an excess portion of the regenerative portion of the electrical energy provided by the charging station.

6. The process according to claim 1, further comprising:
generating, by the electric vehicle or the charging station, a report relating to the charging after the charging.

7. The process according to claim 1, further comprising:
signaling, by the charger of the charging station, a maximum duration of the charging and/or a temporal flexibility of the charging when activating the specific charging mode.

8. A charging station for an electric vehicle, the charging station comprising:
at least one processor; and
at least one memory storing instructions that, when executed by the at least one processor, cause the charging station to:
charge the electric vehicle with electrical energy provided by the charging station while the electric vehicle is connected to the charging station;
optimize a regenerative portion of the electrical energy provided by the charging station during charging in a specific charging mode; and
activate the specific charging mode in response to pressing of a dedicated charging button.

9. A charger for an electric vehicle, the charger comprising:
at least one processor; and
at least one memory storing instructions that, when executed by the at least one processor, cause the charger to:
charge the electric vehicle with electrical energy provided by a charging station while the electric vehicle is connected to the charging station;
optimize a regenerative portion of the electrical energy provided by the charging station during charging in a specific charging mode; and
activate the specific charging mode in response to pressing of a dedicated charging button.

10. An electric vehicle, comprising the charger according to claim 9.
